(19) United States
(12) Patent Application Publication
(10) Pub. No.: US 2017/0101976 A1
(43) Pub. Date: Apr. 13, 2017

(54) Buoyancy Lift Gravity Powered Electrical Generator with Circulating Vessels on Wheels and Helix Glides

(71) Applicant: Brent K. Park, Knoxville, TN (US)

(72) Inventor: Brent K. Park, Knoxville, TN (US)

(21) Appl. No.: 15/080,953

(22) Filed: Mar. 25, 2016

Related U.S. Application Data
(60) Provisional application No. 62/239,040, filed on Oct. 8, 2015.

(51) Int. Cl. F03B 13/00; H02K 7/18

(52) U.S. Cl. CPC F03B 13/00; H02K 7/18; Y10S 74/09; F03B 17/04

(57) ABSTRACT

A buoyancy lift, gravity powered system used to provide continuous input power to electrical or other power generators utilizes a circulating vessel, a lift tower, and a power generating assembly. The lift tower is filled with a volume of fluid having a fluid density greater than a vessel density of the circulating vessel. The circulating vessel is directed upwards along a buoyancy chamber of the lift tower by a rise guide, wherein the circulating vessel is loaded onto a gravity assisted track. The gravity assisted track is helically positioned around a rotary frame connected to a rotor shaft; the rotor shaft being connected to a generator. As the circulating vessel travels downwards around the gravity assisted track, the circulating vessel engages the rotary frame, in turn spinning the rotor shaft to drive the generator. The circulating vessel is then deposited into an inserting pool of the lift tower and recirculated.

The current application claims a priority to the U.S. Provisional Patent application Ser. No. 62/239,040 filed on Oct. 8, 2015.

### FIELD OF THE INVENTION

The present invention relates generally to providing continuous input power to drive a generator. More specifically, the present invention utilizes a lift tower to vertically move circulating vessels, wherein the circulating vessels are deployed to drive a generator.

### BACKGROUND OF THE INVENTION

Watermills and windmills have been around for ages, taking advantage of naturally abundant input power sources. With the increasing need for renewable energies, wind turbines have seen a tremendous growth recently. According to the United States Department of Energy, wind energy accounted for nearly 4.5% of the total energy produced in 2015, and the use of wind-powered generators is growing rapidly.

Most wind turbines are the horizontal-axis wind turbines (HAWTs) with the main rotor shaft and electrical generator at the top of a tower and pointed into the wind. A wind turbine typically uses a wind sensor coupled with a servomotor to keep the wind turbine oriented correctly. The blades of a large wind turbine are coupled to a gearbox that drives an electrical generator. The gearbox converts the low-speed, high-torque rotation of the blades into the quicker rotation needed to drive the generator.

Wind turbines need a large open space with access to the wind and operate only when the wind is in a certain speed range. For megawatt power production, wind turbines need to be mounted at 30 m or more above ground level to take advantage of more stable wind. Wind turbine placement has other challenges; even a single commercial-scale turbine can introduce sounds and safety concerns to the surrounding area.

Less common are the vertical-axis wind turbines (VAWTs), which have the main rotor shaft arranged vertically. One advantage of this arrangement is that the generator and gearbox can be placed near the ground, while a driveshaft transfers energy from the rotor assembly to the ground-based gearbox. An advantage of this design is that accessibility for maintenance is improved; however, the constantly changing direction of the wind forces with reference to the vertically mounted spinning blades results in poor performance and reliability.

The wind turbine power is proportional to wind-speed to the third power. A small change in wind speed results in huge power fluctuations. Anything with an airfoil, ideally, can be 59.3% efficient according to the Betz Law. In reality, the HAWTs are 35% to 40% efficient whereas the efficiency of the VAWTs reaches 30%. The buoyancy force and gravity powered (buoyancy-gravity) generators should be examined as strong alternatives to existing renewable power generators. The buoyancy-gravity generators could operate steadily and continuously, would require comparable or smaller footprints, and could be placed practically anywhere.

The following describes the operation of a buoyancy-gravity generator in general terms based on simple physics: 1) In a water tower, an object less dense than water floats and gains potential energy due to buoyancy force; 2) The object is then placed on a chain or a wheel at about the height of the water tower; 3) A rotor shaft (operated with a chain or a wheel) connected to the generator rotates as gravity pulls the object down to the ground, converting potential energy to kinetic energy; 4) The object is inserted back into the water tower. However, there are no buoyancy-gravity generators in operation that can match the power output of the wind turbines in the range of tens of kilowatt or megawatt production.

The prior art includes examples of ideas that utilize buoyancy and gravity to generate power. Examples of the prior art devices that embody concepts relating to the present invention include: U.S. Pat. No. 20090127866A1 (Cook); U.S. Pat. No. 7,134,283B2 (Vilalobos); U.S. Pat. No. 8,516,812B2 (Manakkattupadeetththil); U.S. Pat. No. 4,718,232A (Willmouth); U.S. Pat. No. 6,734,574B2 (Shin); WO2013128466A2 (Manoj); WO2014128729A2 (Mahadevan); DE102012009226A1 (Gleich). Descriptions of the prior art state that the objects used to drive the generators could take different shapes and that they could be equipped with sensors, self-guidance, and boosters (e.g., propellers) for more precise and controlled (faster or slower) operations.

The Cook patent describes a method to move one object at a time through a fluid-filled tube using a magazine tube connected to the intake tube. Other components required include a crankshaft, a plunger shaft, and a plunger valve. Objects are continually moved to sustain 300 revolutions per minute or 5 revolutions per second. It is apparent that this concept may have practical challenges in handling heavy objects.

The Vilalobos patent provides details of a fluid shaft used in a hermetically sealed buoyancy chamber with at least two separate columns with valves and associated tanks to transfer fluid by injecting air in and out of the two diaphragm-defined chambers inside the tanks.

The Manakkattupadeetththil patent discloses a vertical pipe system to float objects and guide them down through another pipe. As the ball drops, a rotatable flywheel is engaged by a rope. This is a direct-drop method. Each of the spheres rises through a pipe one at a time. An elaborate mechanism is introduced to recycle spheres using a sphere injector system with multiple valves and tubes. It also uses a hard rubber ball to slow down and move the sphere into loading position. From the detailed description, it is reasonable to assume that sphere is small in size and mass, and not appropriate for production of tens of kilowatts or megawatts of electricity.

The Willmouth patent discloses a closed-loop system with a long continuous chain or carrier to which hollow spheres are attached. Multiple valves with pressure control help with movements of the spheres.

The Shin patent utilizes a containment loop for magnetic capsules to pass through coil modules, and electric power is generated. The capsule injector uses a two-gate system to push one capsule at a time. Displaced water may be pumped back into the buoyancy section. Relevant technology to the present invention is a closed-loop system moving one object at a time.

The Manoj patent offers a design to use objects connected to a string to work as the turbine blades.

The Mahadevan patent provides a description of a hollow launching chamber in the lower part of the water tank with three gates. The pulling unit is a lifting arrangement with iron rope and sliding rails. The system uses a direct-drop method to rotate a chain; it derives power from dropping a 10,000 kg object every 30 seconds, lasting less than 3 seconds in duration. Dropping the mass of a semi-truck from the 40-m platform repeatedly is possible but hardly practical.

The Gleich patent describes one object at a time moving up through a fluid column with multiple locks. The fluid column of the lift system is maintained by the air pressure in the drive system. Then the objects are loaded onto a chain successively.

The prior art buoyancy-gravity generators share common features. Specifically, nearly all of them utilize elaborate object-injection systems to recycle objects with different combinations of multiple gates, multiple columns, diaphragms, air pumps, and water pumps. As articulated in the prior art, different fluids might be used in the water tower. For example, seawater is denser than fresh water by ˜2.5%, and it provides additional buoyancy force while lowering the freezing temperature.

In terms of generating electricity, many of the systems described in the prior art utilize a direct drop method: an object is dropped, engaging a chain by means of a rope or similar attachments. Others are similar to wind-turbine technology in that a wheel is used to generate electricity. The buoyancy-gravity generators using a rotating-wheel, resembling a Ferris wheel, provide additional torque proportional to the radius of the wheel. The amount of power that can be produced increases with the radius of the wheel. Similarly, longer wind turbine blades produce more torque, resulting in more electricity. To that extent, the wheel-based systems are more efficient than the direct-drop generators.

All things considered, the prior-art buoyancy-gravity generators have not overcome the difficulties of providing sufficient continuous input power to generate megawatts of electricity. Therefore it is an object of the present invention to provide a system that maximizes the amount of potential energy of a circulating vessel that is converted into rotational motion used to drive a generator. The present invention utilizes a gravity assisted track that is a helical structure that is positioned around a rotary frame connected to a rotor shaft.

The circulating vessel is transported to the top of the gravity assisted track via a buoyancy chamber, wherein the buoyancy chamber is filled with a volume of fluid having a fluid density being greater than a vessel density of the circulating vessel. As such, the circulating vessel rises due to a buoyant force. The circulating vessel is loaded onto the gravity assisted track, wherein the circulating vessel travels in a downwards helical path. The circulating vessel engages the rotary frame, such that the rotor shaft is turned as the circulating vessel traverses along the gravity assisted track. The helical nature of the gravity assisted track provides a greater mechanical advantage over a wheel that is proportional to the number of turns of the gravity assisted track.

### BRIEF DESCRIPTION OF THE DRAWINGS

FIG. 1 is a perspective view of the present invention, wherein the circulating vessel is traversing along the launching section of the gravity assisted track.

FIG. 2 is a perspective sectional view, wherein the circulating vessel is submerged in the volume of fluid within the inserting pool, and wherein the circulating vessel is engaged with the first vessel taxi-mechanism.

FIG. 3 is a perspective sectional view, wherein the circulating vessel is submerged in the volume of fluid within the priming chamber, and wherein the inserting pool and the priming chamber are in fluid communication via the first floodgate being open.

FIG. 4 is a perspective sectional view, wherein the circulating vessel is submerged in the volume of fluid within the buoyancy chamber and engaged with the rise guide, and wherein the buoyancy chamber and the priming chamber are in fluid communication via the second floodgate being open.

FIG. 5 is a perspective view of the staging area at the top of the buoyancy chamber, wherein the circulating vessel is engaged with the second vessel taxi-mechanism.

FIG. 6 is a perspective view of the staging area, wherein the second vessel taxi-mechanism has directed the circulating vessel to the power generating assembly.

FIG. 7 is a perspective view of the staging area, wherein the release mechanism has been opened, allowing the circulating vessel to traverse from the staging area to the gravity assisted track.

FIG. 8 is a perspective view of the present invention, wherein the circulating vessel is traversing along the frame engagement section, while the frame latch is engaged with the vessel engagement member.

FIG. 9 is a top plan sectional view depicting the engagement of the frame latch with the vessel engagement member of the rotary frame.

FIG. 10 is a perspective view of the present invention, depicting the rotation of the rotor shaft and the rotary frame as the circulating vessel traverses along the frame engagement section.

FIG. 11 is a perspective view of the present invention, wherein the circulating vessel has disengaged the rotary frame and is traversing along the release section into the inserting pool.

FIG. 12 is a perspective view of the lift tower and the fluid replenishing mechanism, wherein the inserting pool is in fluid communication with the buoyancy chamber via the fluid replenishing mechanism.

FIG. 13 is a perspective view of the present invention, wherein the radial frame member is helically positioned around the rotor shaft.

### DETAIL DESCRIPTIONS OF THE INVENTION

All illustrations of the drawings are for the purpose of describing selected versions of the present invention and are not intended to limit the scope of the present invention.

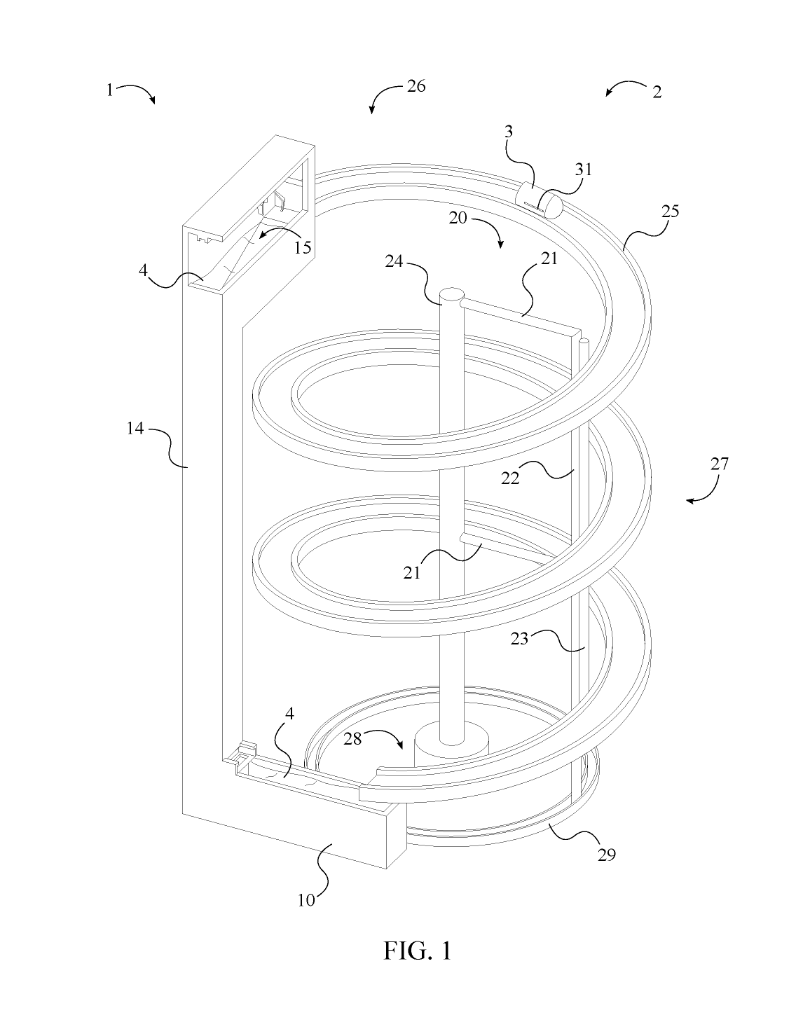

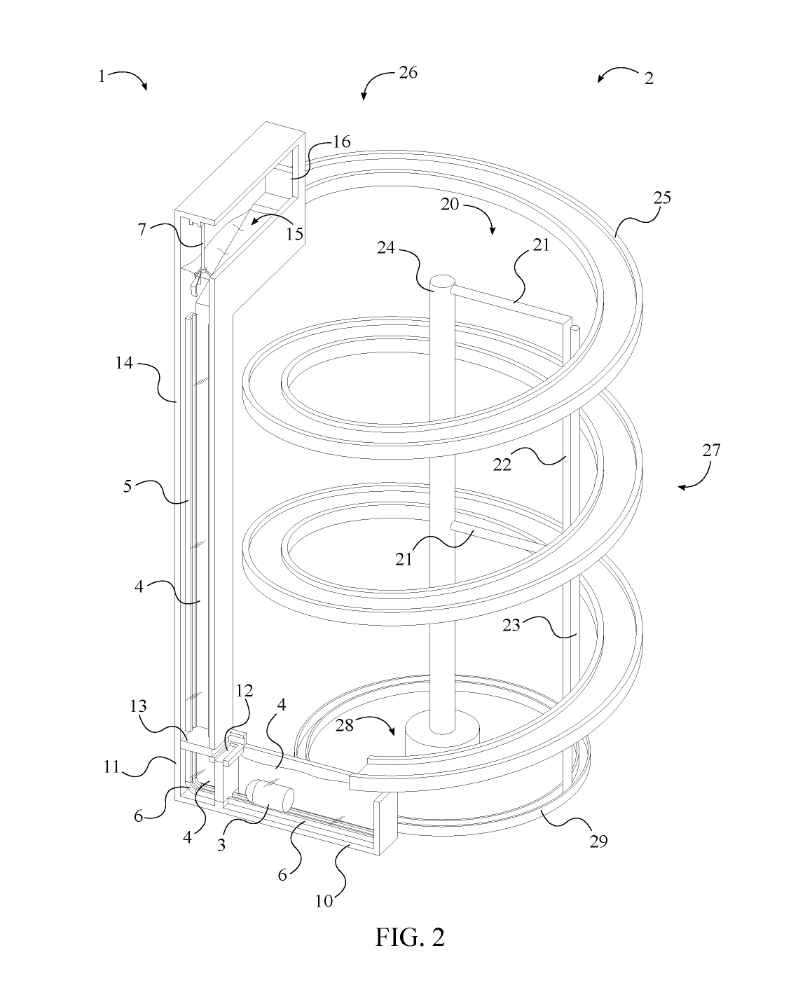

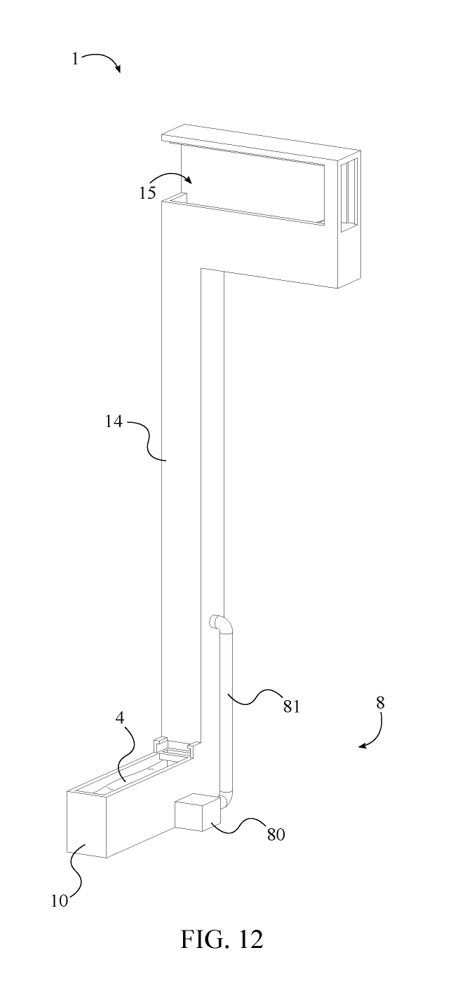

The present invention is a buoyancy lift, gravity powered system used to provide continuous input power to electrical or other power generators. In reference to FIG. 1-2, the present invention comprises a lift tower 1, a power generating assembly 2, a circulating vessel 3, a rise guide 5, a first vessel taxi-mechanism 6, a second vessel taxi-mechanism 7, and a fluid replenishing mechanism 8 shown in FIG. 12. The circulating vessel 3 is navigated to the top of the lift tower 1 via the rise guide 5, wherein the circulating vessel 3 is deployed to drive the power generating assembly 2. The power generating assembly 2 provides one or more rotating structures that are connected to one or more generators.

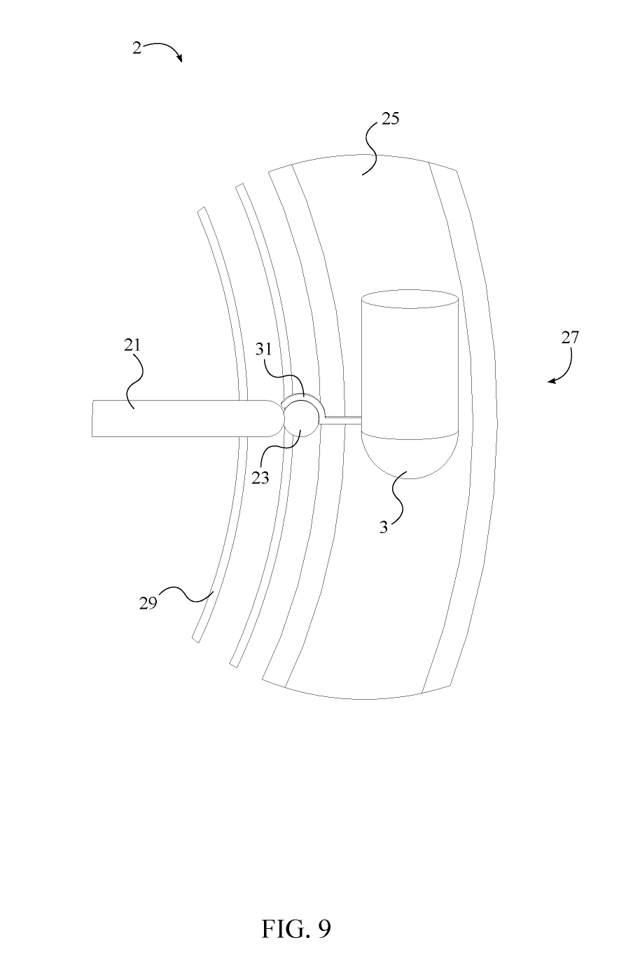

The circulating vessel 3 is provided to continuously operate electrical or other power generators via the power generating assembly 2. The circulating vessel 3 is transported to the top of the lift tower 1 and loaded onto the power generating assembly 2, wherein gravity pulls the circulating vessel 3 downwards. The circulating vessel 3 is engaged with the power generating assembly 2, as shown in FIG. 9, such that the circulating vessel 3 spins the rotating structure as the circulating vessel 3 travels downwards. Revolution of the rotating structure is then translated to the generator in order to produce electricity.

The circulating vessel 3 is carried to the top of the lift tower 1 by a buoyant force. The circulating vessel 3 is designed having a vessel density 30 that will allow the circulating vessel 3 to rise in a volume of fluid 4. In reference to FIG. 2, the lift tower 1 is filled with the volume of fluid 4, wherein the volume of fluid 4 has a fluid density 40 that is greater than the vessel density 30 of the circulating vessel 3. In the preferred embodiment of the present invention, the volume of fluid 4 is water, however, it is possible for the volume of fluid 4 to be a different liquid in other embodiments. The shape of the circulating vessel 3 also affects the rise of the circulating vessel 3 within the volume of fluid 4. In one embodiment, the circulating vessel 3 is designed as a hollow shell and is streamlined, having the shape like that of a bobsled.

The buoyancy of the circulating vessel 3 and the float or rise time are largely determined by the vessel density 30 and shape of the circulating vessel 3. In all embodiments, the circulating vessel 3 is built such that the vessel density 30 is less than the fluid density 40, allowing the circulating vessel 3 to rise to the surface of the volume of fluid 4, near the top of the power generating assembly 2. In some embodiments of the present invention, the circulating vessel 3 comprises a main vessel body and a lift assistance body, wherein the main vessel body is removably attached to the lift assistance body. When attached to the main vessel body, the lift assistance body is used to shuttle the main vessel body to the top of the lift tower 1. The lift assistance body is then detached at the top of the lift tower 1, lowered outside the lift tower 1 using a cable, and returned to an inserting pool 10 of the lift tower 1. The lift assistance body is a hollow structure that acts as a life jacket or swimming tube like device that allows the main vessel body to easily rise to the top of the lift tower 1. For continuous operation of the power generating assembly 2, a plurality of circulating vessels may be employed, wherein deployment of the plurality of circulating vessels is staggered. The specific number of the plurality of circulating vessels required to for continuous operation depends on the rotating speed of the power generating assembly 2 and the rise time of the circulating vessel 3 in the volume of fluid 4. Additionally, the plurality of circulating vessels can be utilized with a plurality of power generating assemblies, wherein one or more of the plurality of circulating vessels is directed down each of the plurality of power generating assemblies.

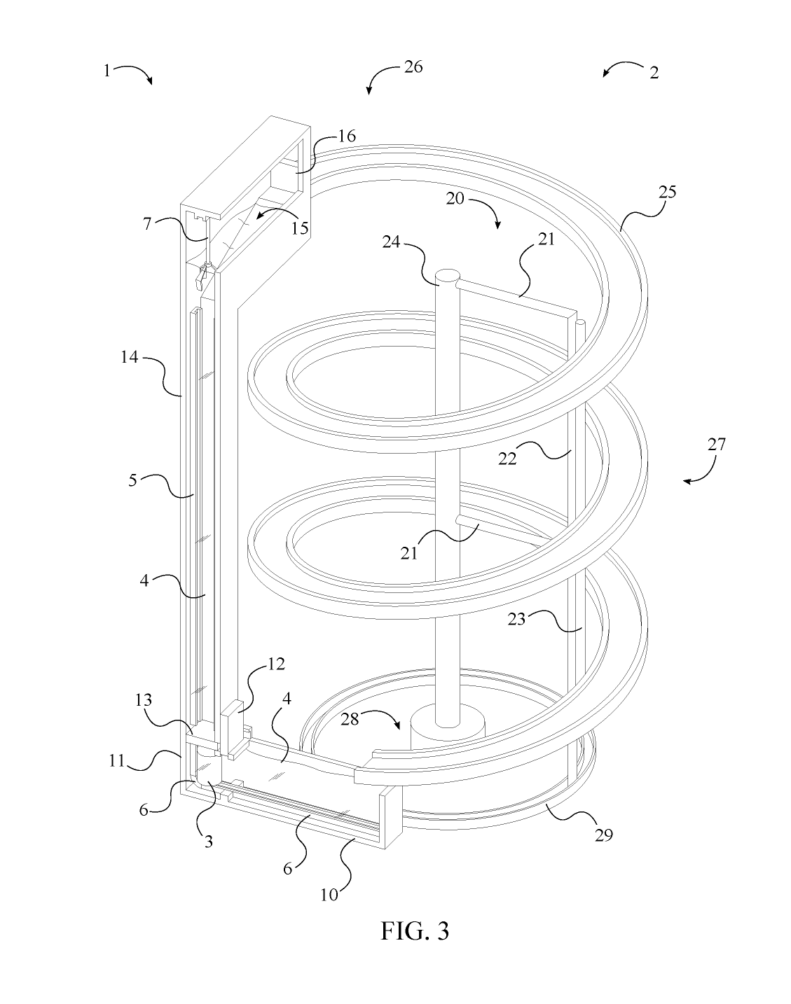

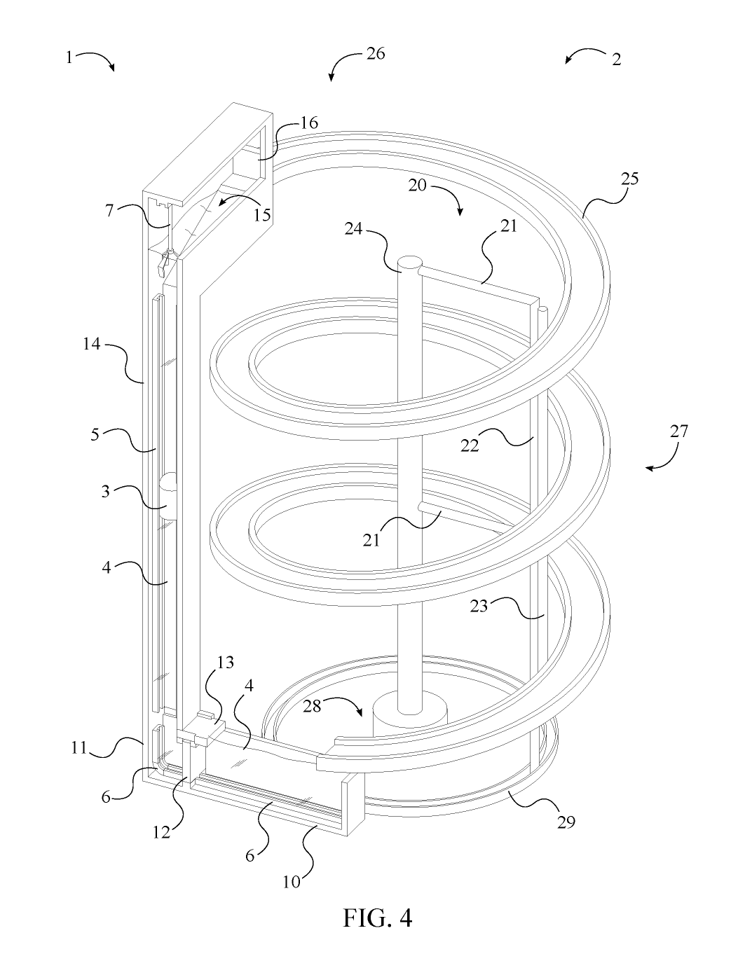

In reference to FIG. 2, the lift tower 1 comprises the inserting pool 10, a priming chamber 11, a first floodgate 12, a second floodgate 13, and a buoyancy chamber 14. The inserting pool 10, the priming chamber 11, and the buoyancy chamber 14 are filled with the volume of fluid 4, wherein the priming chamber 11 is in fluid communication with the inserting pool 10 through the first floodgate 12 as depicted through FIG. 3, and the buoyancy chamber 14 is in fluid communication with the priming chamber 11 through the second floodgate 13 as depicted through FIG. 4. The priming chamber 11 is positioned below the buoyancy chamber 14, while the inserting pool 10 is positioned adjacent to the priming chamber 11; the height of the volume of fluid 4 within the inserting pool 10 being higher than the second floodgate 13. The circulating vessel 3 is directed from the inserting pool 10 to the priming chamber 11 to the buoyancy chamber 14, wherein the circulating vessel 3 rises to the top of the buoyancy chamber 14 to be deployed with the power generating assembly 2.

After the circulating vessel 3 falls due to gravity, the circulating vessel 3 detaches from the power generating assembly 2, wherein the inserting pool 10 receives the circulating vessel 3. The circulating vessel 3 is then transported through the inserting pool 10 by a first vessel taxi-mechanism 6. In reference to FIG. 2, in one embodiment, the first vessel taxi-mechanism 6 is submerged within the volume of fluid 4 and traverses along both the inserting pool 10 and the priming chamber 11. The first vessel taxi-mechanism 6 can be positioned along the bottom, side, or top of the inserting pool 10 and the priming chamber 11. As the circulating vessel 3 enters the inserting pool 10, the circulating vessel 3 engages with the first vessel taxi-mechanism 6. The first vessel taxi-mechanism 6 then directs the circulating vessel 3 through the inserting pool 10 to the first floodgate 12, wherein the circulating vessel 3 is submerged in the volume of fluid 4 within the inserting pool 10 in order to pass through the first floodgate 12.

When the circulating vessel 3 comprises the main vessel body and the lift assistance body, the lift assistance body can be attached to the first vessel taxi-mechanism 6 before the main vessel body enters the inserting pool 10. The main vessel body is deployed from the top of the buoyancy chamber 14 and drives the power generating assembly 2. Upon entering the inserting pool 10, the main vessel body engages with the lift assistance body, wherein the first vessel taxi-mechanism 6 transports the circulating vessel 3 to the priming chamber 11. When the circulating vessel 3 is released from the priming chamber 11, the lift assistance body engages with the rise guide 5, guiding the circulating vessel 3 up to the buoyancy chamber 14.

In other embodiments of the present invention, the first vessel taxi-mechanism 6 is not submerged within the volume of fluid 4. The circulating vessel 3 floats near the surface of the volume of fluid 4 within the inserting pool 10, wherein the circulating vessel 3 traverses along the inserting pool 10 to the first floodgate 12. The first vessel taxi-mechanism 6 is an angled push rod that is positioned above the inserting pool 10. When the first floodgate 12 is opened, the first vessel taxi-mechanism 6 engages the circulating vessel 3, pushing the circulating vessel 3 downwards and through the first floodgate 12 into the priming chamber 11.

Initially, both the first floodgate 12 and the second floodgate 13 are closed, wherein the volume of fluid 4 is isolated in each of the inserting pool 10, the priming chamber 11, and the buoyancy chamber 14, as depicted in FIG. 2. As the circulating vessel 3 traverses through the lift tower 1, only one of the first floodgate 12 or the second floodgate 13 is open at a time. Once the circulating vessel 3 is transported to the first floodgate 12, the first floodgate 12 is opened, wherein the first vessel taxi-mechanism 6 transports the circulating vessel 3 into the priming chamber 11. In reference to FIG. 3, while the first floodgate 12 is opened, the second floodgate 13 is closed. In this way, the volume of fluid 4 is separated above the second floodgate 13 in the buoyancy chamber 14 and below the second floodgate 13 in both the priming chamber 11 and the inserting pool 10; the volume of fluid 4 above the second floodgate 13 and the volume of fluid 4 below the second floodgate 13 each maintaining a separate equilibrium.

The circulating vessel 3 is submerged in the volume of fluid 4 within the priming chamber 11, such that the circulating vessel 3 displaces an amount of the volume of fluid 4 equal to the volume of the circulating vessel 3 into the inserting pool 10. Once the circulating vessel 3 has been transported to the priming chamber 11, the first floodgate 12 is closed, wherein the volume of fluid 4 is again isolated between each of the buoyancy chamber 14, the priming chamber 11, and the inserting pool 10. The second floodgate 13 is then opened, releasing the circulating vessel 3 into the buoyancy chamber 14, wherein the circulating vessel 3 rises to the top of the buoyancy chamber 14, as depicted in FIG. 4.

As the circulating vessel 3 transitions from the priming chamber 11 to the buoyancy chamber 14 and is submerged in the volume of fluid 4 within the buoyancy chamber 14, the circulating vessel 3 displaces an amount of the volume of fluid 4 equal to the volume of the circulating vessel 3 into the priming chamber 11. The second floodgate 13 is then closed, wherein the volume of fluid 4 is again isolated between each of the buoyancy chamber 14, the priming chamber 11, and the inserting pool 10. As a result of the displacement of the volume of fluid 4, when the circulating vessel 3 is removed from the buoyancy chamber 14, the level of the volume of fluid 4 within the buoyancy chamber 14 is decreased by the volume of the circulating vessel 3.

For the continuous circulation of the plurality of circulating vessels, the displacement of the volume of fluid 4 from the buoyancy chamber 14 to the inserting pool 10 is substantial and must be replenished. As such, buoyancy chamber 14 and the inserting pool 10 are in fluid communication through the fluid replenishing mechanism 8. In reference to FIG. 12, the fluid replenishing mechanism 8 comprises a pump 80 and a refill pipe 81; the pump 80 being positioned within the inserting pool 10 and the refill pipe 81 traversing into the buoyancy chamber 14. The refill pipe 81 is connected to the pump 80, such that the buoyancy chamber 14 is in fluid communication with the inserting pool 10 through the pump 80 and the refill pipe 81. The pump 80 dispels an amount of the volume of fluid 4 from the inserting pool 10 and directs the amount of the volume of fluid 4 into the buoyancy chamber 14 via the refill pipe 81.

In one embodiment of the present invention, the pump 80 is a spring-coil operated attachment that operates like a syringe bulb. As the circulating vessel 3 is released from the power generating assembly 2, the circulating vessel 3 enters the inserting pool 10 and engages the pump 80. The remaining kinetic energy of the circulating vessel 3 is used to compress the spring-coil, wherein the circulating vessel 3 makes contact with the pump 80, trapping an amount of the volume of fluid 4 within the pump 80. As the spring-coil is compressed, the amount of the volume of fluid 4 is pushed through the refill pipe 81 into the buoyancy chamber 14. In other embodiments of the present invention, the pump 80 may be an electric pump, or any other device capable of dispelling the volume of fluid 4 from the inserting pool 10 into the buoyancy chamber 14.

If the pump 80 is the spring-coil operated attachment, then the circulating vessel 3 engages with the first vessel taxi-mechanism 6 once the circulating vessel 3 comes to a stop. The first vessel taxi-mechanism 6 is a conveyor belt or track system, wherein the circulating vessel 3 is anchored to a first track slide that guides the circulating vessel 3 through the inserting pool 10 and the priming chamber 11. The first vessel taxi-mechanism 6 is also used to align the circulating vessel 3 with the rise guide 5 when the circulating vessel 3 is positioned within the priming chamber 11, as depicted in FIG. 3. The first vessel taxi-mechanism 6 catches and positions the circulating vessel 3 below the rise guide 5 such that the circulating vessel 3 will rise directly to the rise guide 5 when the second floodgate 13 is opened and the circulating vessel 3 is disengaged from the first track slide.

In another embodiment, when the circulating vessel 3 comprises the main vessel body and the lift assistance body, the lift assistance body can be utilized to displace the volume of fluid 4 from the inserting pool 10 to the buoyancy chamber 14. When the main vessel body is detached from the lift assistance body at the top of the buoyancy chamber 14, the lift assistance body is lowered to the bottom of the buoyancy chamber 14 and into the inserting pool 10. Upon entering the inserting pool 10, the lift assistance body displaces the volume of fluid 4 from the inserting pool 10 to the buoyancy chamber 14 through the refill pipe 81.

In reference to FIG. 4, the rise guide 5 is positioned within the buoyancy chamber 14 and is used to direct the circulating vessel 3 through the buoyancy chamber 14 in a controlled manner. As such, the rise guide 5 is positioned along the buoyancy chamber 14, from the second floodgate 13 to a staging area 15 of the buoyancy chamber 14; the staging area 15 being terminally positioned opposite the priming chamber 11. When the second floodgate 13 is opened, the circulating vessel 3 engages the rise guide 5, wherein the rise guide 5 directs the circulating vessel 3 through the volume of fluid 4 within the buoyancy chamber 14. The rise guide 5 minimizes the travel time through the buoyancy chamber 14 by providing the path of shortest distance and eliminating causes of interference along the path.

The rise guide 5 can be designed in many different ways. The following provides exemplary embodiments of the rise guide 5: a single-bar guide rail onto which the circulating vessel 3 latches; a double-bar guide rail onto which the circulating vessel 3 latches, wherein the double-bar guide rail provides stability on opposing sides of the circulating vessel 3; a rail having three or more bars, wherein the circulating vessel 3 is positioned in between the bars, as opposed to latching onto the bars; a tube into which the circulating vessel 3 is positioned; a tube or track with integrated permanent magnets; an electromagnetic track. It is also possible for any other similar apparatus to be used to guide the circulating vessel 3 upwards along the buoyancy chamber 14.

A plurality of rise guides can be employed when using the plurality of circulating vessels, such that more than one vessel can be guided to the top of the buoyancy chamber 14 at a time. The plurality of rise guides can be arranged in any desirable configuration in order to promote the most efficient transportation and distribution of the plurality of circulating vessels. In one embodiment of the present invention, each of the plurality of rise guides is arranged linearly across the buoyancy chamber 14. In another embodiment, the plurality of rise guides is clustered. The exact configuration of the plurality of rise guides depends on the practical constraints of the present invention, such as the power consumption of the first floodgate 12 and the second floodgate 13, and the specific way in which the present invention is employed, such as whether or not multiple power generating assemblies are utilized.

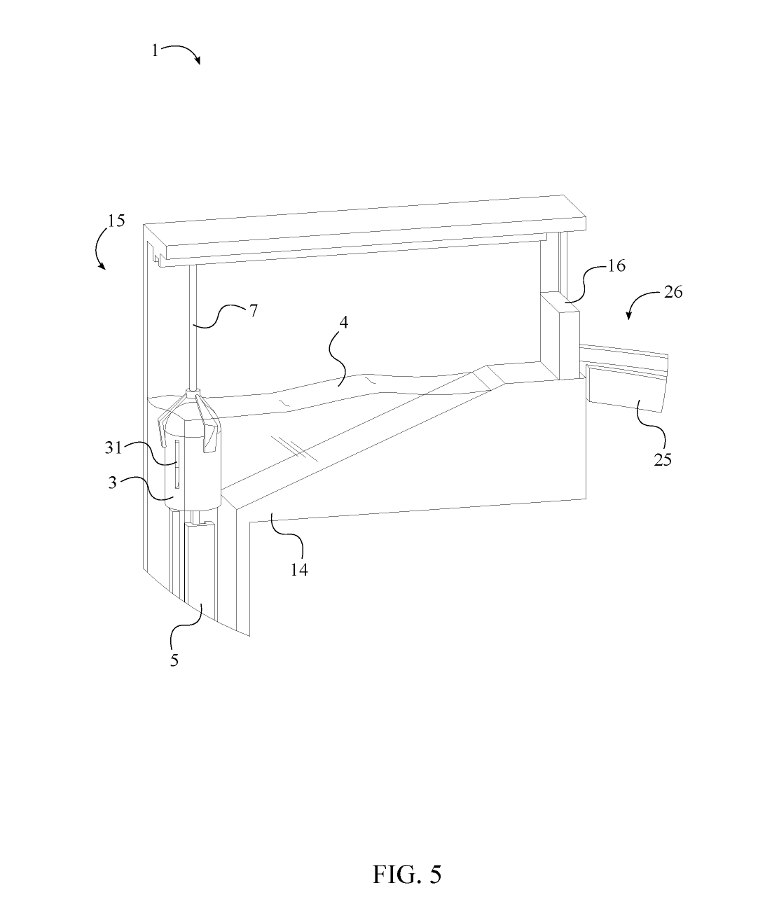

In reference to FIG. 5, once the circulating vessel 3 reaches the top of the buoyancy chamber 14, a second vessel taxi-mechanism 7 is utilized to shuttle the circulating vessel 3 from the lift tower 1 to the power generating assembly 2. The circulating vessel 3 engages with the second vessel taxi-mechanism 7, wherein the second vessel taxi-mechanism 7 directs the circulating vessel 3 similar to the first vessel taxi-mechanism 6. In the preferred embodiment of the present invention, the second vessel taxi-mechanism 7 is a conveyor belt or track system, wherein the circulating vessel 3 engages with a second track slide.

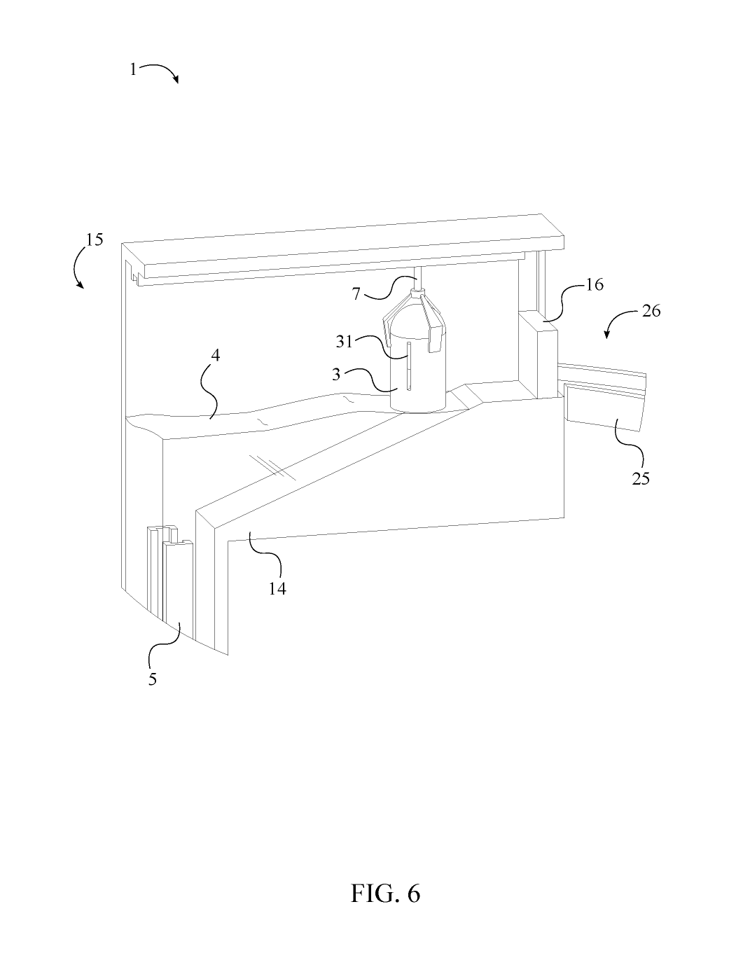

In another embodiment of the present invention, the second vessel taxi-mechanism 7 is a crane like catcher and loader. A catcher arm secures the circulating vessel 3 near or below the surface of the volume of fluid 4 and pivots to move the circulating vessel 3 along the staging area 15 to the power generating assembly 2. The second vessel taxi-mechanism 7 can also be a combination of a track system and a catcher and loader system. In reference to FIG. 5-6, in one embodiment, the second vessel taxi-mechanism 7 utilizes a catcher arm that is slidably positioned along a track. The second vessel taxi-mechanism 7 engages the circulating vessel 3 and transports the circulating vessel 3 along the staging area 15 as depicted between FIG. 5 and FIG. 6.

In further reference to FIG. 5, the staging area 15 is submerged in the volume of fluid 4 and may be segmented in order to accommodate the plurality of circulating vessels. Additionally, the staging area 15 is an inclined section of the lift tower 1, such that the circulating vessel 3 is directed upwards, out of the volume of fluid 4 as the circulating vessel 3 is directed along the staging area 15. The staging area 15 directs the circulating vessel 3 to the power generating assembly 2, wherein the circulating vessel 3 is disengaged from the second vessel taxi-mechanism 7, allowing the circulated vessel to be directed downward due to gravity.

In reference to FIG. 1, in the preferred embodiment of the present invention, the power generating assembly 2 comprises a rotary frame 20, a rotor shaft 24, a gravity assisted track 25, and a frame track 29. The rotor shaft 24 is connected to the generator and is positioned vertically with respect to the ground. The rotary frame 20 is radially connected to the rotor shaft 24, wherein the rotary frame 20 is positioned along the rotor shaft 24 and extends outwards from the rotor shaft 24 in at least one direction. The rotary frame 20 comprises a support cross-structure 21 and a radial frame member 22; the support cross-structure 21 being radially connected to the rotor shaft 24 and the radial frame member 22 being terminally connected to the support cross-structure 21 opposite the rotor shaft 24.

In further reference to FIG. 1, the support cross-structure 21 determines the distance between the rotor shaft 24 and the radial frame member 22, and thus the torque needed to rotate the rotor shaft 24. The support cross-structure 21 is at least one cross-member that extends from the rotor shaft 24. In the preferred embodiment of the present invention, the support cross-structure 21 includes a horizontal cross-member and a pair of diagonal cross-members, wherein the radial frame member 22 is supported at the midpoint and both ends. In addition to being braced by the support cross-structure 21, the radial frame member 22 is supported by the frame track 29. The radial frame member 22 is slidably connected to the frame track 29, wherein the frame track 29 supports the bottom of the radial frame member 22 and assists in guiding the radial frame member 22 in a circular path around the rotor shaft 24; the frame track 29 being concentrically positioned around the rotor shaft 24.

In another embodiment of the present invention, the support cross-structure 21 is a solid panel that extends from the rotor shaft 24. In this way, the radial support member 22 is supported along an edge that is defined by the size of the support cross-structure 21, as opposed to individual points. The support cross-structure 21 being a solid panel can be flat or curved similar to a turbine blade. Additionally, the support cross-structure 21 could be constructed from composite materials such as fiberglass to provide a high strength to weight ratio. However, it is possible for any other types of materials to be used in the construction of the support cross-structure 21.

In some embodiments, the power generating assembly may further comprise at least one subsequent rotary frame. The subsequent rotary frame is radially connected to the rotor shaft 24, wherein the subsequent rotary frame is positioned along the rotor shaft 24, extending outwards from the rotor shaft 24 opposite the rotary frame 20 or in another direction offset from the rotary frame 20. Similar to the rotary frame 20, the subsequent rotary frame comprises a subsequent support cross-structure and a subsequent radial frame member; the subsequent support cross-structure being radially connected to the subsequent rotor shaft and the subsequent radial frame member being terminally connected to the subsequent support cross-structure opposite the rotor shaft 24. The subsequent rotary frame aims to provide improved stability and the ability to readily accommodate multiple circulating vessels.

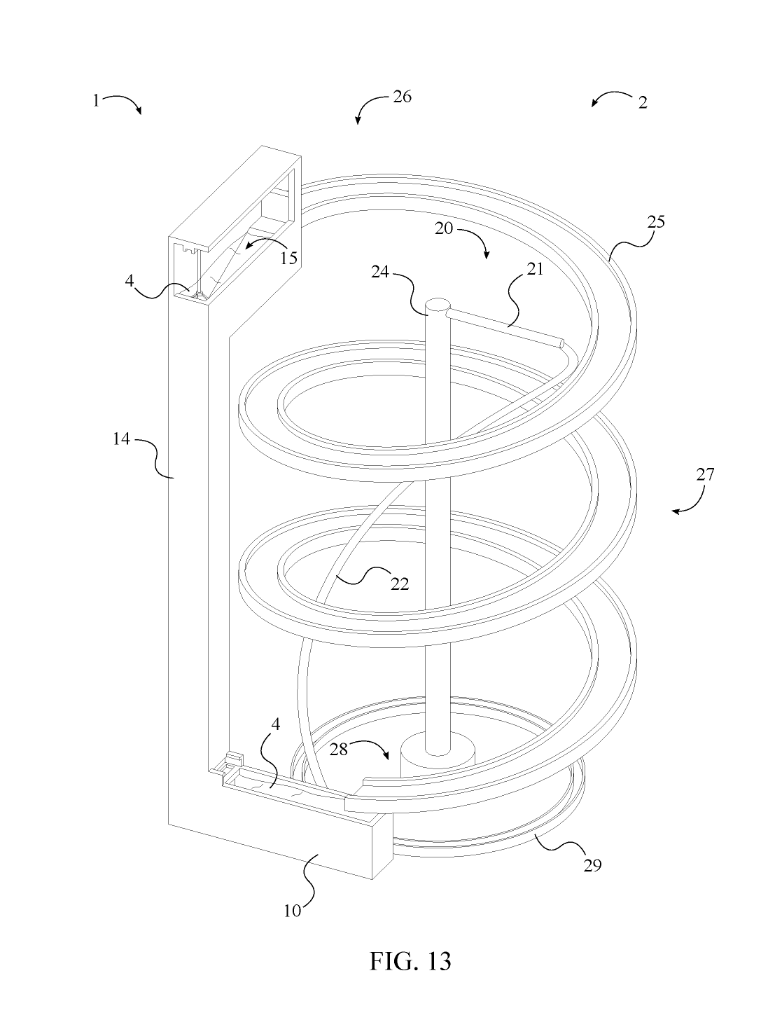

In the preferred embodiment of the present invention, the radial frame member 22 is positioned parallel to the rotor shaft 24 as depicted in FIG. 1, wherein together the rotor shaft 24 and the rotary frame 20 form a rectangular shape. In another embodiment of the present invention, the radial frame member 22 is helically positioned around the rotor shaft 24, as depicted in FIG. 13. The exact shape of the radial frame member 22 is influenced by the type of connection between the circulating vessel 3 and the rotary frame 20, as well as the number of circulating vessels used and the spacing between the deployment of each of the circulating vessels.

The gravity assisted track 25 is any inclined plane, glide, track, etc. that guides the circulating vessel 3 downwards from the staging area 15 to the interesting pool 10. In reference to FIG. 1, in the preferred embodiment, the gravity assisted track 25 is helically positioned around the rotary frame 20 and comprises a launching section 26, a frame engagement section 27, and a release section 28. The launching section 26 and the release section 28 are positioned opposite each other along the frame engagement section 27, wherein the launching section 26 is adjacently connected to the buoyancy chamber 14 opposite the priming chamber 11. As such, the release section 28 is positioned adjacent to the inserting pool 10. The second vessel taxi-mechanism 7 delivers the circulating vessel 3 to the launching section 26, wherein the circulating vessel 3 disengages from the second vessel taxi-mechanism 7 and begins descending along the launching section 26. The launching section 26 provides a length of the gravity assisted track 25 along which the circulating vessel 3 can gain momentum before engaging the rotary frame 20.

In another embodiment, when the circulating vessel 3 comprises the main vessel body and the lift assistance body, only the main vessel body traverses along the gravity assisted track 25. When the circulating vessel 3 reaches the top of the lift tower 1, the main vessel body detaches from the lift assistance body, wherein the main vessel body then engages with the second vessel taxi-mechanism 7. The second vessel taxi-mechanism 7 transfers the main vessel body from the staging area 15 to the launching section 26, wherein the main vessel body is deployed down the gravity assisted track 25. Such an embodiment is advantageous, as the main vessel body is smaller than the circulating vessel 3 overall, allowing for the gravity assisted track 25 to be made more compact (smaller turn-spacing provides more turns and longer power generation, less resistance, etc.).

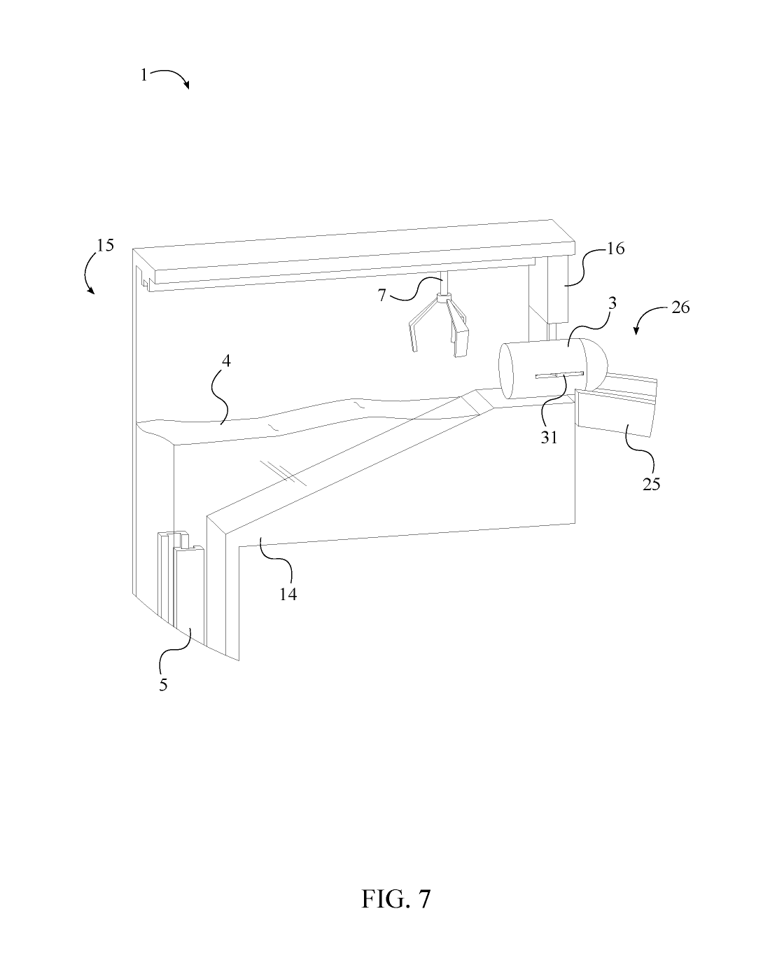

In some embodiments of the present invention, the lift tower 1 further comprises a release mechanism 16. The release mechanism 16 is operably positioned in between the staging area 15 and the launching section 26, wherein the release mechanism 16 is used to regulate the delivery of the circulating vessel 3 onto the gravity assisted track 25, as depicted by FIG. 6-7. In a closed position as shown in FIG. 6, the release mechanism 16 prevents the circulating vessel 3 from being discharged onto the launching section 26. In an open position as shown in FIG. 7, the release mechanism 16 is retracted allowing the circulating vessel 3 to pass to the launching section 26. The release mechanism 16 may be manually operated or automatically operated using a timer or sensors. The release mechanism 16 is used to regulate the deployment of the circulating vessel 3 when using the plurality of circulating vessels, allowing for the synchronization of each of the plurality of circulating vessels.

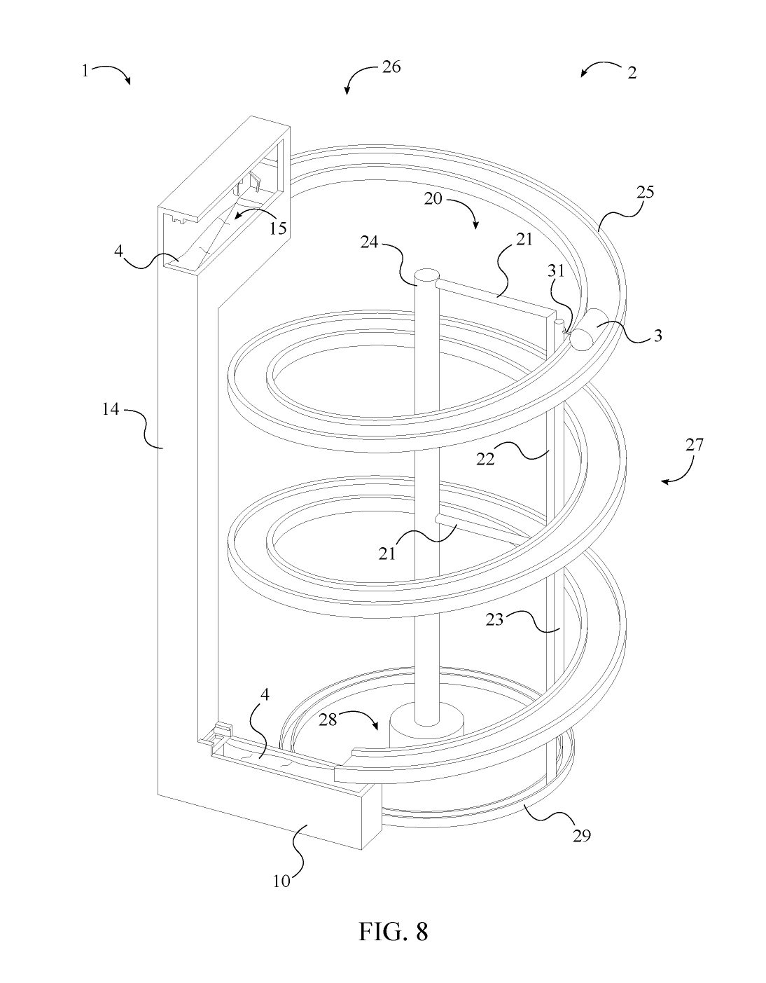

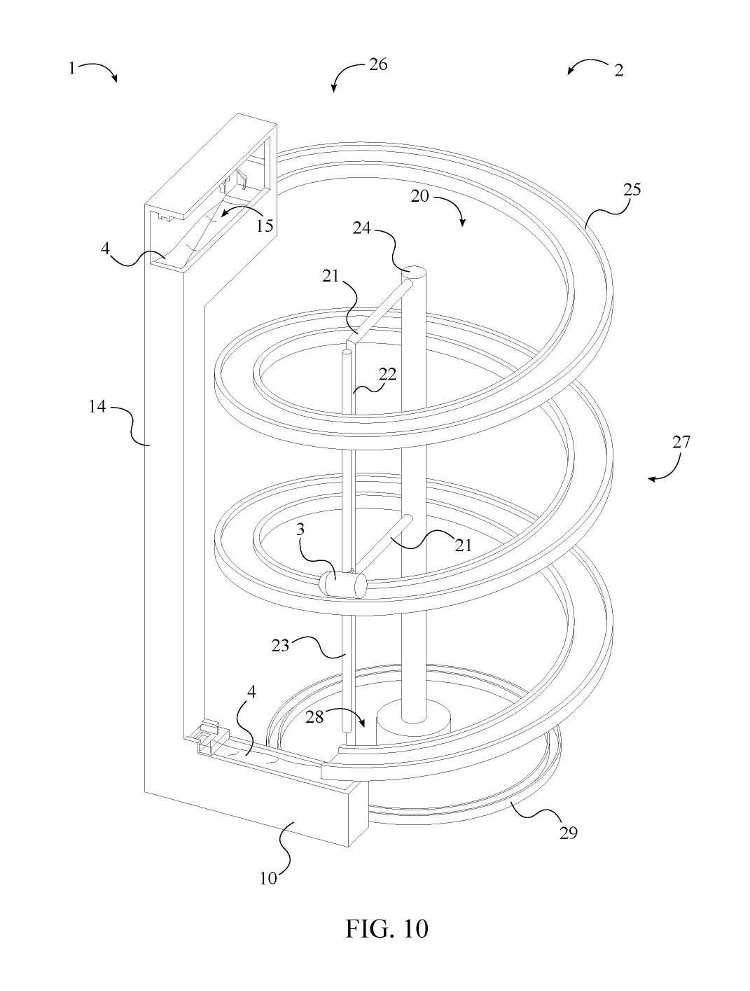

The frame engagement section 27 encompasses a majority of the gravity assisted track 25 and is the portion along which the circulating vessel 3 is engaged with the rotary frame 20. The circulating member gains momentum through the launching section 26 and then enters the frame engagement section 27, wherein the circulating vessel 3 engages the rotary frame 20, as depicted in FIG. 8. The rotary frame 20 further comprises a vessel engagement member 23; the vessel engagement member 23 being adjacently connected to the radial frame member 22 opposite the rotor shaft 24. The circulating vessel 3 latches onto, or otherwise connects to, the vessel engagement member 23. As the circulating vessel 3 travels in a downwards spiral along the frame engagement section 27, the circulating vessel 3 pulls the rotary frame 20 as depicted between FIG. 8 and FIG. 10, spinning the rotor shaft 24, wherein the spinning of the rotor shaft 24 drives the generator.

In order to attach to the vessel engagement member 23, the circulating vessel 3 comprises a frame latch 31 depicted in FIG. 9, which is a hook like extension that catches onto the vessel engagement member 23. The vessel engagement member 23 is positioned along the radial frame member 22 allowing the circulating vessel 3 to remain engaged with the rotary frame 20 along the entirety of the frame engagement section 27. As the circulating vessel 3 travels along the frame engagement section 27, the frame latch 31 remains engaged with the vessel engagement member 23, wherein the frame latch 31 is able to slide downwards along the vessel engagement member 23.

The circulating vessel 3 may be designed such that the frame latch 31 is retractable into a body of the circulating vessel 3. In this way, the frame latch 31 would not impede the movement of the circulating vessel 3 along the launching section 26 or the release section 28. Ideally the deployment of the frame latch 31 from the body, and the retraction of the frame latch 31, is triggered automatically using a plurality of vessel sensors built into the circulating vessel 3. The plurality of vessel sensors is able to detect the position of the circulating vessel 3 along the gravity assisted track 25 and then actuate the frame latch 31 accordingly. The frame latch 31 could also be manually triggered or automatically triggered through the use of a timer.

In addition to tracking the position of the circulating vessel 3, the plurality of vessel sensors can also be utilized to monitor the speed of the circulating vessel 3, any rotation of the circulating vessel 3, or any other desirable information in regards to the circulating vessel 3. The circulating vessel 3 may also comprise a fill material that is positioned within a recess of the body of the circulating vessel 3. The fill material is utilized to manipulate the center of gravity of the circulating vessel 3 for more effective handling and use. Preferably, the fill material is a slow moving gel such that the center of gravity of the circulating vessel 3 remains low and rotation of the circulating vessel 3 is avoided as the circulating vessel 3 traverses along the gravity assisted track 25. The avoidance of rotation of the circulating vessel 3 is ideal, as some of the potential energy of the circulating vessel 3 is wasted.

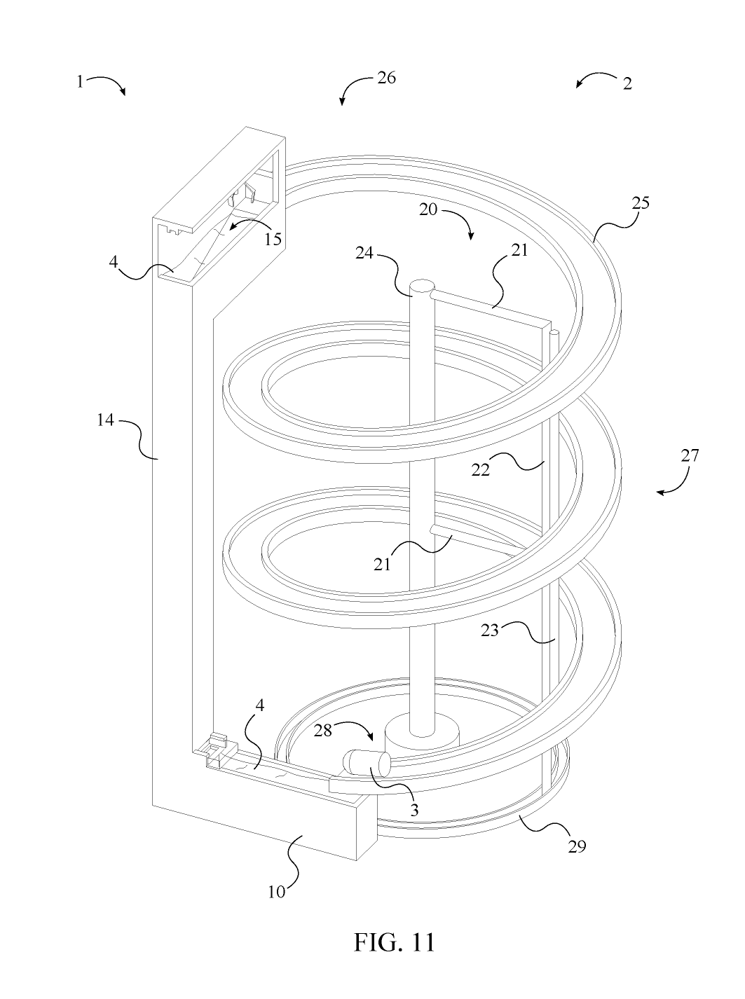

The vessel engagement member 23 terminates along the radial frame member 22 at the height where the frame engagement section 27 meets the release section 28. In this way, the frame latch 31 slips off of the vessel engagement member 23 as the circulating vessel 3 enters the release section 28, as depicted in FIG. 11. Similar to the launching section 26, the circulating vessel 3 is not attached to the rotary frame 20 as the circulating vessel 3 travels along the release section 28. The release section 28 directs the circulating vessel 3 into the inserting pool 10, wherein the circulating vessel 3 is again loaded into the priming chamber 11 and transported to the top of the power generating assembly 2 via the buoyancy chamber 14.

Each of the launching section 26, the frame engagement section 27, and the release section 28 may have a different pitch, or helix turn angle, in order to manipulate the speed of the circulating vessel 3 along the gravity assisted track 25. For example, the launching section 26 may have a higher pitch than the frame engagement section 27, allowing the circulating vessel 3 to gain more speed before engaging with the rotary frame 20 at the start of the frame engagement section 27. The variance in the pitch of each of the launching section 26, the frame engagement section 27, and the release section 28 can also be used to manipulate the speed of the circulating vessel 3 in order to time each cycle of the circulating vessel 3 when using the plurality of circulating vessels.

In one embodiment of the present invention, the power generating assembly 2 further comprises a plurality of magnets. The plurality of magnets is positioned along the gravity assisted track 25 and is used to propel the circulating vessel 3 along the gravity assisted track 25. A first set of magnets from the plurality of magnets is lined along one wall of the gravity assisted track 25, while a second set of magnets from the plurality of magnets is lined along the opposing wall of the gravity assisted track 25. The first set of magnets and the second set of magnets is oriented such that opposite poles are facing inwards on the gravity assisted track 25. The circulating vessel 3 is constructed at least in part from ferro-magnetic materials such that the magnetic fields of the plurality of magnets directs propels the circulating vessel 3 along the gravity assisted track 25.

In another embodiment of the present invention, an electromagnetic system is integrated into the gravity assisted track 25 and the circulating vessel 3. Coils are built into the gravity assisted track 25, while magnets are built into the circulating vessel 3. Current is applied through the coils in order to generate magnetic fields that propel the circulating vessel 3 along the gravity assisted track 25. It is also possible for any other type of magnetic system to be employed between the gravity assisted track 25 and the circulating vessel 3 to assist in propelling the circulating vessel 3 downwards along the gravity assisted track 25.

Since the present invention is presented as a viable alternative to wind turbine generators, the performance and efficiency factors of the buoyancy lift, gravity powered system need to be discussed. For a valid comparison, it is assumed that the diameter of the gravity assisted track 25 are comparable to the diameter of a rotor assembly for a typical wind turbine. The following analysis is carried out using the specifications of the typical wind turbine having a rotor diameter of ˜80 m with a rotor speed of 12 to 15 rpm, or 0.2 to 0.25 rev/s, and a torque of 955,000 N m at 0.25 rev/s, and thus a power output of 1.5 MW according to the following equation:

Power (Watt)=Torque (N m)×2π×rev/s (1)

Mainly due to lack of useable wind, the average annual power production for the typical wind turbine is limited to 30 to 40% of the wind turbine generator's rating. Meanwhile, the present invention relies on buoyancy force that is constant and available all the time. When the product of torque and speed is matched, the present invention would also produce megawatt electricity as the typical wind turbine.

The gravity assisted track 25 essentially replaces the rotor assembly in the typical wind turbine. For the present invention to generate 1.5 MW of electricity using the same generator, the power generating assembly 2 should provide the same horsepower to rotate the generator.

The circulating vessel 3 being 5000 kg, would produce comparable torque when moving down the gravity assisted track 25 and rotating the rotary frame 20 having a 40 m radius (the same as the radius of the rotor assembly on the typical wind turbine producing 1.5 MW). An average helix turn angle of 45 degrees is assumed. Since gravity is the source of the input power:

$$\begin{matrix}Torque = Force \times radius \\ = 5000 kg \times 9.8 \frac{m}{{s}^{2}} \times sin ( 45 deg ) \times 40 m \\ = 1 , 385 , 929 N m\end{matrix} \qquad ( 2 )$$

The calculation in equation (2) is the first-order calculation for the circulating vessel 3 being pulled down by gravity on a 45 degree inclined plane—without taking friction or other inefficiencies into account. The gravity assisted track 25 being a helix is essentially a rolled-up inclined plane. With a small adjustment in the helix turn angle, 5% to 10% of overall inefficiencies could easily be addressed.

The first step is to verify that there is an adequate amount of potential energy at the beginning of the downward cycle along the gravity assisted track 25. Assuming a launching height of 46 m between the launching section 26 and the vessel engaging section of the gravity assisted track 25: 6 m is provided for the height of launching section 26, allowing the circulating vessel 3 to gain an optimum speed; and 40 m is provided for the height of the frame engagement section 27 and the height of the vessel engagement member 23 to which the circulating vessel 3 is engaged throughout the descent. The height of 46 m is less than half the height of a comparable wind turbine. The wind turbines with 80-m diameter blades, are mounted ˜30 m from the ground—making the structures 110 m tall.

At the top (46 m), with the circulating vessel 3 starting at rest, the total energy comes from the potential energy of the circulating vessel 3:

$$\begin{matrix}Total Energy = Potential Energy + Kinetic Energy \\ = mass \times gravity \times the launching height + 0 \\ = 5000 kg \times 9.8 \frac{m}{{s}^{2}} \times 46 m \\ = 2 , 254 , 000 N m \end{matrix} \qquad ( 3 )$$

In a passive mode of operation (i.e. the circulating vessel 3 starting from rest), the circulating vessel 3 could slide along the launching section 26, down a height of 6 m, at a helix turn angle of 45 degrees to acquire 11 m/s speed, or approximately 40 km/h or 25 mi/h, before engaging the rotary frame 20. It is practical and also beneficial to put more energy into the system by pushing the circulating vessel 3 down the gravity assisted track 25. If the circulating vessel 3 is pushed down, then either faster speed could be achieved or the slide length along the launching section 26 could be reduced.

The helix turn angle controls the speed of circulating vessel 3. The present invention provides repeatable and precise speed since the helix turn angle is at the designer's control. The kinetic energy from a 5000 kg mass moving at 11 m/s is substantial at 302,500 N m, and increases as velocity squared. By pushing the circulating vessel 3 down the launching section 26 being longer, it is practical to achieve the speed of 27 m/s (˜60 mi/hr), which gives the kinetic energy of 1,822,500 N m.

$$\begin{matrix}Kinetic Energy = \frac{1}{2} \times mass \times {velocity}^{2} \\ = \frac{1}{2} \times 5000 kg \times {( 27 m \text{/} s )}^{2} \\ = 1 , 822 , 500 N m\end{matrix} \qquad ( 4 )$$

When this kinetic energy is added to the initial potential energy of 2,254,000 N m, the total energy in the system is more than 4,000,000 N m.

Although the calculation in equation (4) is only a quality check, one could verify that the circulation vessel being 5000 kg provides ample initial input energy to generate 1.5 MW of electricity. With up to four times the torque needed, the present invention can accommodate slower moving circulating vessels that are desirable for safety and for noise reduction during the operation.

The typical 1.5 MW wind turbine operates at 12 to 15 rpm for peak power production. This is equivalent to a wind turbine blade-tip speed of 48 to 60 m/s. The present invention with much more torque would allow the circulating vessel 3 moving at 27 m/s or even slower speed to produce comparable energy output continuously—not just at 30 to 40% productivity.

Increasing the mass of the circulation vessel would linearly increase the total energy, while increasing the speed of the circulation vessel would increase the kinetic energy by the square of the speed. The present invention easily compensates for any system-level inefficiencies with small changes in the mass and speed of the circulating vessel 3, in addition to the helix turn angle.

With the frame engagement section 27 being 40 m tall and a 1.5 m turn-spacing, there are 26 turns throughout the frame engagement section 27. The usable distance for generating electricity with the circulating vessel 3 is the circumference of the path of the radial frame member 22 times the number of turns of the radial frame member 22:

$$\begin{matrix}Distance = π \times diameter \times number of turns \\ = 3.14 \times 80 m \times 26 \\ = 6531 m\end{matrix} \qquad ( 5 )$$

With a constant speed of 27 m/s, the circulating vessel 3 moving down on the gravity assisted track 25 generates power for 4 min by rotating the rotary frame 20. It is relatively straightforward to make the present invention bigger or smaller by controlling the radius of the rotary frame 20, the height of the gravity assisted track 25, the helix turn-spacing, the helix turn angle, the mass of the circulating vessel 3, etc.

At the beginning of the operation, it is critical to ensure that the rotary frame 20 achieves at least the minimum speed before the circulating vessel 3 engages the vessel engagement member 23. The circulating vessel 3 moving at a high speed would create a catastrophic event encountering the rotary frame 20 being stationary. A sensor system would make sure that the frame latch 31 would not engage if the rotary frame 20 is not moving at the desired speed. The circulating vessel 3 on the gravity assisted track 25 then sustains the rotation continuously.

At the beginning of the operation, it is possible to gradually start moving the rotary frame 20 with a passive use of the circulating vessel 3. As the rotary frame 20 picks up speed, the speed of the circulating vessel 3 could be increased to the production level. Or the rotary frame 20 could be initially powered to move at the desired speed, before introducing circulating vessels onto the power generating assembly 2.

To safely land the circulating vessel 3 at the end of each journey, while maintaining the kinetic energy of the circulating vessel 3 for power production, the helix turn angle is further optimized near the exit. More specifically, the helix turn angle of the release section 28 is optimized. As the circulating vessel 3 reaches the release section 28 of the gravity assisted track 25, most of the kinetic energy has been used to rotate the rotor shaft 24 via the rotary frame 20 in order to generate electricity. The circulating vessel 3, equipped with brakes for speed control, is released from the vessel engagement member 23 onto release section 28, wherein the circulating vessel 3 is guided into the inserting pool 10 to be used again. The desired release angle and speed of the circulating vessel 3 determine the curvature of the release section 28.

Instead of operating the power generating assembly 2 with only the circulating vessel 3 being 5000 kg, the plurality of circulating vessels could be employed, wherein the total mass of the plurality of circulating vessels is sufficient to provide the required torque. For example, the plurality of circulating vessels could be specifically two vessels, wherein the mass of each of the two vessels is 2500 kg. Any other combinations of masses between the plurality of circulating vessels that would produce the torque needed could also be used. Of course, there are challenges with synchronizing each of the plurality of circulating vessels, as each of the plurality of circulating vessels is spaced apart on the gravity assisted track 25 in order to drive the rotor shaft 24. The following discusses the movement of the plurality of circulating vessels being separated, not the movement of the plurality of circulating vessels as a unit, which is essentially one object.

For steady electricity production, it would be preferred to have the plurality of circulating vessels move at nearly constant speed on the gravity assisted track 25. This is true especially when each of the plurality of circulating vessels is used simultaneously for additive power production (e.g., when two 2500 kg vessels are used on gravity assisted track 25 to generate the torque needed to turn one generator). With the aid of the plurality of vessel sensors and minimal speed control of the plurality of circulating vessels, synchronizing the speed of each of the plurality of circulating vessels is a relatively simple exercise.

The following analysis is performed for each of the plurality of circulating vessels having a mass of 2500 kg. Assuming the speed in equation (4) for each of the plurality of circulating vessels and the usable distance in equation (5), one of the plurality of circulating vessels would be loaded onto the gravity assisted track 25 every 2 min in order to produce the torque in equation (2). Two of the plurality of circulating vessels would be on the gravity assisted track 25 at all times and would be producing the torque in equation (2). Each of the plurality of circulating vessels moves at nearly constant speed, providing additive power. Increasing the number of the plurality of circulating vessels on the gravity assisted track 25 and increasing the number of turns of the gravity assisted track 25 would generate more electricity. Up to a point, increasing the mass of each of the plurality of circulating vessels achieves the same outcome.

In another embodiment of the present invention, the rotor shaft 24 is positioned horizontally with respect to the ground and the power generating assembly 2 does not include the gravity assisted track 25. The radial frame member 22 forms a wheel structure that is concentric with the rotor shaft 24, wherein the support cross-structure 21 includes a plurality of cross members radially positioned around the rotor shaft 24 that brace the radial frame member 22. The power generating assembly 2 further comprises a plurality of carriers; the plurality of carriers being radially positioned around the rotor shaft 24.

Each of the plurality of carriers is adjacently connected to the radial frame member 22 and provides a means for receiving, securing, and unloading the circulating vessel 3. The circulating vessel 3 is loaded into one of the plurality of carriers from the staging area 15 using the second vessel taxi-mechanism 7. Once the circulating vessel 3 is loaded into one of the plurality of carriers, the circulating vessel 3 falls downwards due to gravity, turning the rotary frame 20 and the rotor shaft 24. Each of the plurality of circulating vessels can be loaded sequentially into the plurality of carriers in order to increase the torque applied to the rotor shaft 24.

When the circulating vessel 3 reaches the bottom of the cycle of the rotary frame 20, the circulating vessel 3 is released directly into the inserting pool 10. The way in which the circulating vessel 3 is released is dependent on the design of each of the plurality of carriers. In one embodiment of the plurality of carriers, each of the plurality of carriers is pivotally connected to the radial frame member 22, wherein each of the plurality of carriers can be rotated to dump the circulating vessel 3 into the inserting pool 10. In another embodiment of the plurality of carriers, each of the plurality of carriers has a lower release gate, wherein the lower release gate can be toggled between an open and closed position. The circulating vessel 3 is loaded on top of the lower release gate being in the closed position. When the circulating vessel 3 is above the inserting pool 10, the lower release gate is switched to the open position, wherein the circulating vessel 3 is released through the bottom of the carrier. It is also possible for any other release mechanism to be used to deploy the plurality of circulating vessels from the plurality of carriers into the inserting pool 10.

In summary, the present invention combines buoyancy force and gravity to generate input power. The present invention provides a strong alternative to wind turbines, especially when used with the gravity assisted track 25 with the plurality of circulating vessels. The present invention provides advantages over the wind turbines when it comes to siting, scalability, and steady and continuous operation. Some of the wind turbines have diameters of 70 m or more and generate megawatts of electricity. They are mounted 30 m or higher from the surface to use relatively steady wind. Wind turbines are typically placed far away from residential areas and spaced far apart to minimize wind interference from each other. Additionally, wind turbine generators are designed to operate with variable and sudden wind speed and withstand gusts up to 200 km/h. This requires exquisite failsafe and sophisticated operating controls with expensive and maintenance prone components. Since the present invention can select the speed at which the plurality of circulating vessels travel downwards, the present invention does not require these special features in the generators, thereby reducing substantial costs for generator production and operations.

Although the invention has been explained in relation to its preferred embodiment, it is to be understood that many other possible modifications and variations can be made without departing from the spirit and scope of the invention as hereinafter claimed.

What is claimed is:

1. A buoyancy lift, gravity powered electrical generator comprises:
a lift tower;
a power generating assembly;
a circulating vessel;
the lift tower comprises an inserting pool, a priming chamber, a first floodgate, a second floodgate, and a buoyancy chamber;
the power generating assembly comprises a rotary frame, a rotor shaft, and a gravity assisted track;
the gravity assisted track comprises a launching section, a frame engagement section, and a release section;
the priming chamber being in fluid communication with the inserting pool through the first floodgate;
the buoyancy chamber being in fluid communication with the priming chamber through the second floodgate;
the inserting pool, the priming chamber, and the buoyancy chamber being filled with a volume of fluid having a fluid density being greater than a vessel density of the circulating vessel;
the rotary frame being radially connected to the rotor shaft;
the gravity assisted track being helically positioned around the rotary frame;
the launching section and the release section being positioned opposite each other along the frame engagement section; and
the launching section being adjacently connected to the buoyancy chamber opposite the priming chamber.

2. The buoyancy lift, gravity powered electrical generator as claimed in claim 1 comprises:
the release section being positioned adjacent to the inserting pool.

3. The buoyancy lift, gravity powered electrical generator as claimed in claim 1 comprises:
a rise guide;
the rise guide being positioned within the buoyancy tower; and
the rise guide being positioned along the buoyancy tower.

4. The buoyancy lift, gravity powered electrical generator as claimed in claim 3 comprises:
the circulating vessel engaging the rise guide tube.

5. The buoyancy lift, gravity powered electrical generator as claimed in claim 1 comprises:
the rotary frame comprises a support cross-structure and a radial frame member;
the support cross-structure being radially connected to the rotor shaft; and
the radial frame member being terminally connected to the support cross-structure opposite the rotor shaft.

6. The buoyancy lift, gravity powered electrical generator as claimed in claim 5 comprises:
the radial frame member being positioned parallel to the rotor shaft.

7. The buoyancy lift, gravity powered electrical generator as claimed in claim 5 comprises:
the radial frame member being helically positioned around the rotor shaft.

8. The buoyancy lift, gravity powered electrical generator as claimed in claim 1 comprises:
the power generating assembly further comprises a frame track;
the rotary frame comprises a radial frame member;
the frame track being concentrically positioned around the rotor shaft; and
the radial frame member being slidably connected to the frame track.

9. The buoyancy lift, gravity powered electrical generator as claimed in claim 1 comprises:
the rotary frame comprises a radial frame member and a vessel engagement member;
the vessel engagement member being adjacently connected to the radial frame member opposite the rotor shaft; and
the vessel engagement member being positioned along the radial frame member.

10. The buoyancy lift, gravity powered electrical generator as claimed in claim 1 comprises:
the circulating vessel comprises a frame latch;
the circulating vessel being positioned on the frame engagement section; and
the frame latch engaging the rotary frame.

11. The buoyancy lift, gravity powered electrical generator as claimed in claim 10 comprises:
the rotary frame comprises a vessel engagement portion; and
the frame latch being engaged with the vessel engagement portion.

12. The buoyancy lift, gravity powered electrical generator as claimed in claim 1 comprises:
the circulating vessel being submerged in the volume of fluid within the inserting pool.

13. The buoyancy lift, gravity powered electrical generator as claimed in claim 1 comprises:
the circulating vessel being submerged in the volume of fluid within the priming chamber.

14. The buoyancy lift, gravity powered electrical generator as claimed in claim 1 comprises:
the circulating vessel being submerged in the volume of fluid within the buoyancy chamber.

15. The buoyancy lift, gravity powered electrical generator as claimed in claim 1 comprises:
a first vessel taxi-mechanism; and
the first vessel taxi-mechanism traversing along the inserting pool and the priming chamber.

16. The buoyancy lift, gravity powered electrical generator as claimed in claim 15 comprises:
the circulating vessel being engaged with the first vessel taxi-mechanism.

17. The buoyancy lift, gravity powered electrical generator as claimed in claim 1 comprises:
a second vessel taxi-mechanism;
the buoyancy chamber comprises a staging area;
the launching section being adjacently connected to the staging area; and
the second vessel taxi-mechanism traversing along the staging area to the launching section.

18. The buoyancy lift, gravity powered electrical generator as claimed in claim 17 comprises:
the lift tower further comprises a release mechanism; and
the release mechanism being operably positioned in between the staging area and the launching section.

19. The buoyancy lift, gravity powered electrical generator as claimed in claim 17 comprises:
the circulating vessel being engaged with the second vessel taxi-mechanism.

20. The buoyancy lift, gravity powered electrical generator as claimed in claim 1 comprises:
a fluid replenishing mechanism;
the fluid replenishing mechanism comprises a pump and a refill pipe;
the pump being positioned within the inserting pool;
the refill pipe traversing into the buoyancy chamber; and
the buoyancy chamber being in fluid communication with the inserting pool through the pump and the refill pipe.
